(19) United States
(12) Patent Application Publication
(10) Pub. No.: US 2014/0116296 A1
(43) Pub. Date: May 1, 2014

(54) BUILDING MATERIAL PRODUCED FROM A COMBINATION OF NATURAL PRODUCTS AND ASHES OF DECEASED PETS AND/OR HUMANS

(71) Applicant: Bobby Gerald Williams, Duluth, GA (US)

(72) Inventor: Bobby Gerald Williams, Duluth, GA (US)

(21) Appl. No.: 13/665,766

(22) Filed: Oct. 31, 2012

(51) Int. Cl. C04B 14/06; C04B 18/06; B28B 3/00; C04B 14/10

(52) U.S. Cl. 106/706; 264/333

(57) ABSTRACT

A method can use the ashes of pet or human remains and combining them with natural materials and chemical stabilizers to form, under high pressure, strong building materials. These internment blocks can be formed in an unlimited variety of shapes and weights and can be used to build permanent structures. The ashes are forever protected from the elements and are in a final resting place as part of the memorial structure. The building blocks require zero perpetual care and can last up to or beyond 1000 years. The building blocks can be designed into a lasting memorial of the size and scope desired. In their final cured state, the building blocks can be as hard as stone and impervious to moisture.

### BACKGROUND OF THE INVENTION

The present invention relates to building materials produced from natural products, chemical stabilization and high pressure in combination with the ashes of deceased pets and/or humans, and more particularly, to forming a building block with pet or human cremation ashes that can then be formed into a memorial structure.

For many centuries, the cost of permanent memorials has been the domain of Kings, Emperors and Pharos who could divert the wealth and productivity of the nations to their purpose. In modern times, cemeteries have existed for a few hundred years generally undisturbed, but there have been limited alternatives for those choosing cremation. Unless one goes to the expense of buying a burial lot and placing the ashes in the ground, something already rejected by the deceased, the options are limited.

The ash remains of pets or humans are not a permanent place of rest for these deceased individuals. The disposition of these ashes is an open question. Many owners or survivors store these ashes at home for the remainder of their lives. When they pass, these ashes are an unknown item for heirs and others making final arrangements and are at the mercy of the executor, who may not have known the person or pet in question. These remembrances that were precious to the owner/survivor are not so with the executor or the cleaning crew. Dumping ashes of deceased loved ones can hardly compare with making them part of a lasting memorial where thousands of beloved individuals find their final rest.

As can be seen, there is a need for a method for providing a permanent and final resting place for the deceased pet or human ashes.

### SUMMARY OF THE INVENTION

In one aspect of the present invention, a method for making an internment block unit comprises combining a friable clay, small aggregate, sand and a hardening agent to create a product mixture; adjusting the moisture content of the product mixture and mixing for a first predetermined period of time to create a mixed product; transferring the mixed product to a mold and applying a pressure to the mold for a second period of time to create a post-pressure treatment building block; and allowing the post-pressure treatment building block to cure after removing the pressure.

In another aspect of the present invention, an internment block unit comprises a mixture of friable clay, small aggregate, sand, hardening agent and ash remains, the mixture being placed under pressure for a predetermined period of time prior to curing.

These and other features, aspects and advantages of the present invention will become better understood with reference to the following drawings, description and claims.

### BRIEF DESCRIPTION OF THE DRAWINGS

FIG. 1 is a flow chart describing a method for making an ash remains building block according to an exemplary embodiment of the present invention;

FIG. 2 is a perspective view of a cubic building block;

FIG. 3 is a perspective view of a circular building block;

FIG. 4 is a perspective view of a multi-angled cubic building block;

FIG. 5 is a perspective view of a concave cylindrical building block; and

FIG. 6 is a perspective view of a mushroom-shaped building block, wherein FIGS. 2 through 6 show examples of the shapes that the ash remains building blocks can be configured.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method for taking ashes of pet or human remains and combining them with natural materials and chemical stabilizers and forming, under high pressure, strong building materials therewith. These building blocks can be formed in an unlimited variety of shapes and weights and can be used to build permanent structures. The ashes are forever protected from the elements and are in a final resting place as part of the memorial structure. The building blocks require zero perpetual care and can last up to or beyond 1000 years. The building blocks can be designed into a lasting memorial of the size and scope desired. In their final cured state, the building blocks can be as hard as stone and impervious to moisture.

The methods of the present invention provides the lasting qualities of the Pharos and a a physical memorial, the permanence of a cemetery, and the strength of modern science, mechanics and chemistry.

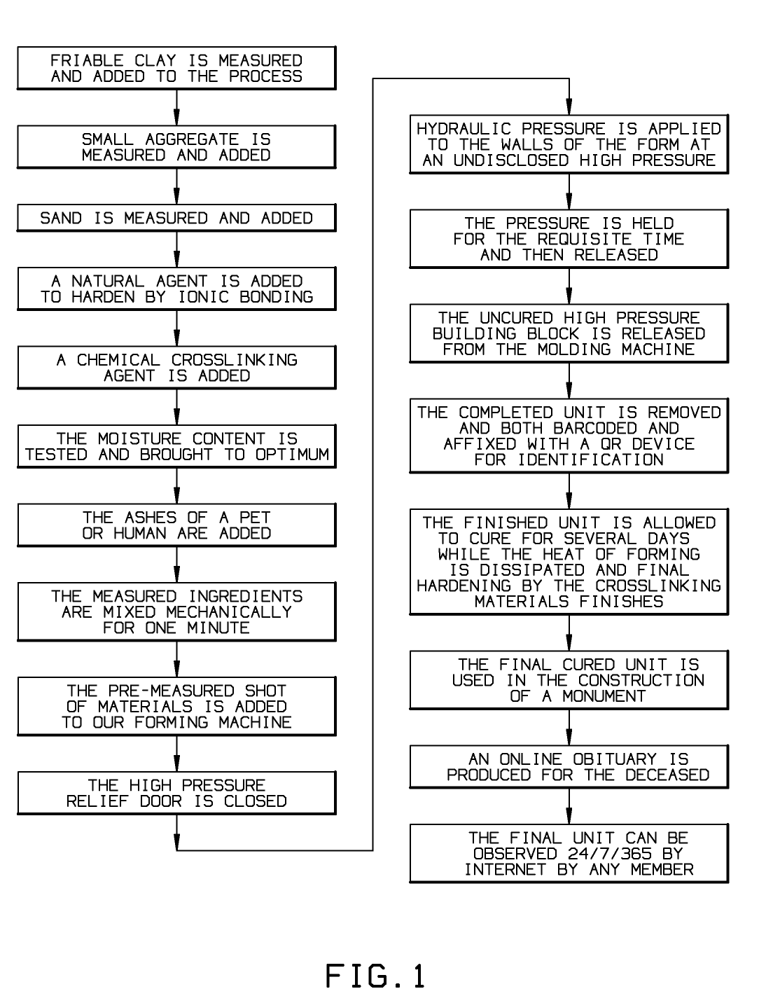

Referring to FIG. 1, a friable clay can be measured and added to a container. Small aggregate and sand can be measured and added with the friable clay. A natural agent can then be added to harden by ionic bonding. A chemical cross-linking agent can optionally be added at this phase in the process. The moisture content can be tested and brought to an optimum level and the ashes of a pet or human can then be added.

The clay can be of various types. Many types of clay exist naturally and are distinguished by particle size, color and the nature of the source, as some clays contain more or less organic material depending on the source. The process of the present invention can work with any “clean” clay that can be moisture adjusted. Common red, ferris clay and whit caolin clays have been used most often.

When a claim has been properly selected, it is important to reduce its free moisture content to 10% or less by air drying and storing it away from rain or flooding.

Many types of aggregates can work, however, the maximum size should be small enough to pass through a ⅛ inch screen. The minimum should be greater in size than common river sand. The fines from rock crushing, especially granite because of the sharp and irregular shapes are ideal. In some embodiments, glass (recycled) that was crushed in a ball mill could be used. While glass can make a good quality block, it can be abrasive to equipment and care should be taken.

The sand used in the present invention can be river or building sand. The sand should be clean and free of trash and organic material. The proper mix of the selected clay, aggregate and sand are added to a mixing device and mixed. The measured ingredients can be mixed mechanically for several minutes. The moisture content is checked and a small amount of water, with a chemical surfactant, can be sprayed onto the material while the mixing is resumed.

A mixture of naturally occurring inorganic compounds, such as calcium oxide, calcium silicate and magnesium oxide, can be added as hardening aids. The cremation remains can be added and the final hardening and water treatment ingredients can be added. These ingredients can include a number of products that, in combination, assist in the curing and chemical bonding of the hardening agents, produce strength, even if the blocks are immersed in water, and provide a water repellant surface tension for the block on the surface and throughout. Liquid latex, alkyl ketene dimer, alkyl ketene dimer in combination (homogenized) with polymer wet strength resins, neutral pH sizing agents from the paper or textile industries, and/or reactive silicone can be used. While not every one of these items can be used in every blend, various combinations of these items may be used as well as various substitutes.

When all of the ingredients have been properly dry mixed, a pre-measured shot can be added to a forming machine. A high pressure relief door can be closed and hydraulic pressure can be applied to the walls of a form at a high pressure, typically from about 1500 psi to about 6000 psi. The pressure can be held for a predetermined period of time, such as from about one minute to about one hour and then released. The uncured, high-pressure treated building block can be released from the molding machine and allowed to cure. The curing can take several days, depending upon ambient temperature at that time.

Typically, the building blocks can be labeled with a barcode and/or a QR device for identification. The curing process can take several days while the heat of forming is dissipated and final hardening by the crosslinking of materials finishes.

The final cured unit can be used in, for example, the construction of a monument. In some embodiments the monument can be accessible through, for example, an internet connection, smartphone app, or the like. In some embodiments, an online obituary can be published to describe the deceased and provide a mechanism for survivors to view/visit the memorial.

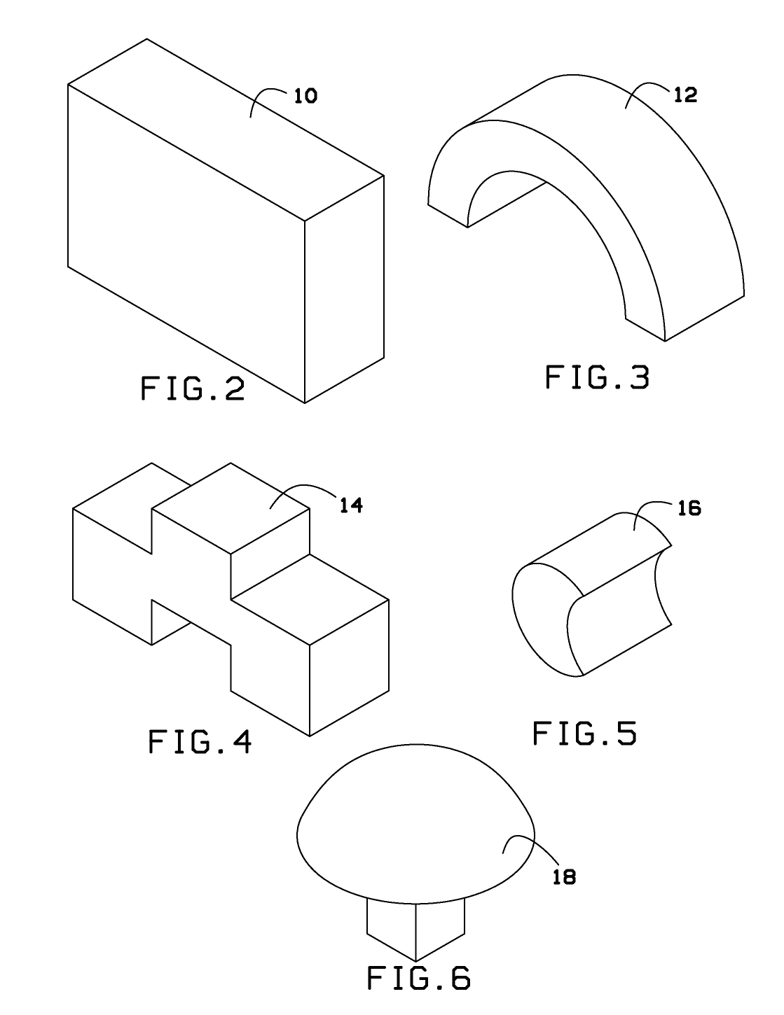

As shown in FIGS. 2 through 6, the forms can take various shapes and sizes. Other geometric or non-geometric shapes are within the scope of the present invention.

In some embodiments, a self-curing ketene dimer or a reactive silicone can be added to provide an additional level of water protection. Such additives can limit capillary action in what little porosity remains in the building blocks formed by the methods of the present invention.

In the memorial structures themselves, roof tops, siding and other materials can encapsulate the basic building units of the present invention. Even paint can be used to add an additional element of protection of the finished units.

Each of the materials used in the process of the present invention has a known surface area per gram of material in order to provide a mixture having specified proportions of ingredients to result in a hard, long-lasting building block unit.

The building block units of the present invention can be used for various structures or memorials. For example, the building block units can be used to create grottos, fish ponds, towers, walls, mazes and a variety of interesting and useful applications for the ashes of a deceased loved one. By being encapsulated in the building blocks, no one can ever disturb them again and the monument can be designed, for example, for their visiting kin.

The building blocks made by a process of the present invention can be used, with or without ash remains, for building various items, from general building to landscape products.

It should be understood, of course, that the foregoing relates to exemplary embodiments of the invention and that modifications may be made without departing from the spirit and scope of the invention as set forth in the following claims.

What is claimed is:

1. A method for making an internment block unit, comprising:
combining a friable clay, small aggregate, sand and a hardening agent to create a product mixture;
adjusting the moisture content of the product mixture;
mixing for a first predetermined period of time to create a mixed product;
transferring the mixed product to a mold and applying a pressure to the mold for a second period of time to create a post-pressure treatment building block; and
allowing the post-pressure treatment building block to cure after removing the pressure.

2. The method of claim 1, further comprising adding ash remains of a pet or human to the product mixture.

3. The method of claim 1, wherein the pressure applied to the mold is from 1500 psi to 6000 psi.

4. The method of claim 3, wherein the pressure is applied from about 1 minute to about 60 minutes.

5. The method of claim 1, further comprising adding a chemical crosslinking agent to the product mixture.

6. The method of claim 1, further comprising adding a chemical strength additive to the product mixture.

7. The method of claim 1, further comprising adding a water repelling agent to the product mixture.

8. The method of claim 1, further comprising applying an identification feature to the post-pressure treatment building block.

9. The method of claim 2, further comprising using the building block unit to create a memorial.

10. The method of claim 9, further comprising providing remote viewing of the memorial.

11. An internment block unit comprising:
a mixture of friable clay, small aggregate, sand, hardening agent and ash remains, the mixture being placed under pressure for a predetermined period of time prior to curing.

12. The building block unit of claim 11, further comprising a chemical crosslinking agent added to the mixture.
